(19) United States
(12) Patent Application Publication
(10) Pub. No.: US 2026/0318015 A1
(43) Pub. Date: Oct. 15, 2026

(54) MASTIC ASPHALT SURFACE TEXTURE AND METHOD FOR IRONWORKS

(71) Applicant: TARSTONE LTD., Navan (IE)

(72) Inventors: Cathal FAHY, Navan (IE); Ernie LYNCH, Navan (IE); Lorna LYNCH, Navan (IE)

(21) Appl. No.: 19/550,682

(22) Filed: Feb. 26, 2026

Related U.S. Application Data
(60) Provisional application No. 63/783,542, filed on Apr. 4, 2025.

(51) Int. Cl. E01C 11/16; C08L 95/00

(52) U.S. Cl. CPC E01C 11/165; C08L 95/00

(57) ABSTRACT

Provided is a transition material for the interface between a flexible road surface and a rigid surface and methods for laying said transition material, the transition material comprising a base layer comprising mastic asphalt; a surface layer comprising pre-coated aggregate with particle sizes in the range of 2 mm to 10 mm embedded in the upper surface of the base layer.

### RELATED APPLICATIONS

This application claims the benefit of U.S. Provisional Patent Application No. 63/783,542, filed Apr. 4, 2025, which application is incorporated herein by reference in its entirety.

### TECHNICAL FIELD

This invention relates to mastic asphalt surface texture for surrounding ironworks in a road or pathway. More particularly, the invention relates to a mastic asphalt surface texture for surrounding ironworks on greenways, cycleways, footpaths, around bollards, and for mastic channels on the outer edges of roads.

Statement regarding prior disclosures by the inventor or a joint inventor UK Patent Publication No. GB 2633058A (“the '058A publication”), filed Aug. 30, 2023, and published Mar. 5, 2025, is the inventor's own work and published less than one year before the effective filing date of the instant application. Accordingly, the '058A publication is not citable as prior art under the exemptions provided by 35 U.S.C. § 102(b)(1)(a).

### BACKGROUND

Many roads are paved with hot rolled asphalt (HRA) and stone mastic asphalt (SMA). Hot rolled asphalt derives its skid resistance from the use of 14 mm to 20 mm pre coated aggregate which is embedded in the surface after laying using a roller. Stone Mastic Asphalt (SMA) is an open texture material which has an aggregate size of 10 mm to 14 mm embedded throughout the mixture. A typical laying process for SMA includes laying a base binder followed by a surface course. In Ireland and the UK, the availability of natural rock sources for SMA and HRA has led to the dominance of this surfacing process. While in some regions of the world, mastic asphalt (MA) is used for normal road surfacing, mastic asphalt is used mainly used in Ireland and the UK (and other regions where HRA and SMA dominate) for the installation of ironworks (i.e., manholes, hydrants, gullies, etc.).

Mastic asphalt is a dense mixture consisting of coarse aggregate and bitumen, which acts as a binder, and optionally sand, and/or limestone fine aggregate, and/or filler. Mastic asphalt has a low air void content. The bitumen content is so adjusted that all voids between aggregate are completely filled. Mastic asphalt is solid or semi solid under normal temperature conditions but sufficiently fluid when brought to a suitable temperature to be pourable and spread by hand. Due to the inherent lack of voids, it requires no compaction on site, unlike HRA and SMA. The strength of mastic asphalt comes from the bitumen rather than interlocking aggregate. Various grades of bitumen may be used for different applications such as paving grade, hard grade and polymer modified bitumen.

By their nature, road surfaces made from HRA and SMA are flexible. However, when the surface course of these flexible road surfacing materials comes into contact with rigid ironworks which are installed in the road, a deterioration in the road surface around the ironworks occurs. Over time, the effects of dynamic traffic loading causes the engineering brick foundation support underneath the ironworks to deteriorate, leading to settlement and eventually cracks and potholes in the surface material which poses a potential safety hazard.

One way of avoiding this problem is to put ironworks into concrete road and path sections. However, this is not always possible, as it depends on where the services are needed and where the underground networks are located.

The method currently used to address the problem of the interface between SMA or HRA and ironworks is to install the ironwork on top of a bedding of engineering bricks and polymer modified mastic asphalt (PMMA) a polymer modified mastic asphalt-referred to herein as a “transition material”—as a surface material to provide a smooth transition from the flexible asphalt to the rigid ironworks. This helps to distribute the displacement over a larger area both horizontally and vertically. However, this solution poses a separate safety hazard since the surface of the transition material is slippery, particularly when wet. Attempts to resurface this modified mastic asphalt transition material in order to provide skid resistance with aggregate of approximately 10 mm to 14 mm or 14 mm to 20 mm, similar to the surrounding roads, was found not to provide shoulder-to-shoulder coverage. As used herein, the term shoulder-to-shoulder coverage means that the aggregate particles have no spaces between them, i.e. they are in contact with each other, which is required for the required level of skid resistance. For example 100% shoulder-to-shoulder coverage means there are no spaces between the aggregate. 70% coverage means the amount of aggregate spread is 70% of the amount determined to be 100%.

When applied, pre-coated aggregates of 14 mm to 20 mm result in a coverage with spaces between the aggregate meaning they do not provide skid resistance for the narrow wheels of bicycles, prams, wheelchairs, roller blades and the likes. This is particularly a problem at the outer edges of roads where ironworks associated with drainage often necessarily coincide with cycle lanes. Another approach, which is currently used, is to embed large pre-coated aggregate of approximately 30 mm in the mastic asphalt, at a distance of approximately 100 mm apart. The large pre-coated aggregate which are currently used to provide skid resistance also cause perceptible bumps in the surface for bicycle and wheelchair users and the likes, since their tyres are narrower and maintained at a higher pressure than those of cars. The large pre-coated aggregate are also perceptible to pedestrians and may comprise a trip hazard. With the known benefits of active transport for health, accessibility and the environment, road surfaces need to be safe and comfortable for all road users.

Therefore, there is a need for a transition material which can eliminate the problems which arise at the interface between flexible road surfaces and rigid structures, while providing a safe, comfortable surface for all road users.

### Definitions

The term “ironworks” refers to any components formed from metal embedded into a road or path, such as gullies, drains, manholes, tramways, rail tracks, sluice valve covers, inspection chamber covers and the likes. However, the invention is also applicable to the interface of road surfaces with any rigid materials, which may include railings, barriers, lampposts, walls, stone kerbing and so on.

The term “transition material” is used herein to describe compositions used as materials used at the interface between asphalt and ironworks.

Particle sizes referred to herein indicate sieve mesh sizes. Thus, aggregate of 2 mm to 4 mm passes through a sieve with a mesh of 4 mm but not through a sieve with a mesh of 2 mm.

Polymer Modified Mastic Asphalt (PMMA) is designed to be of low void content, The binder content is adjusted so that the voids are completely filled. PMMA is pourable and can be spread in its working temperature condition. It requires no compaction on site. This mixture is very durable and in certain countries is used as a surface course. See Shell Bitumen Handbook 6th Edition.

Stone Mastic Asphalt (SMA) is a gap graded asphalt with bitumen as a binder comprised of a coarse crushed aggregate Skelton bond with a mastic mortar. This mixture is often used as surface layer in cases where high stability is needed. The surface structure generates low noise levels. See Shell Bitumen Handbook 6th Edition.

Hot Rolled Asphalt (HRA) is a dense gap graded asphalt in which the mortar of fine aggregate filler and high viscosity binder are major contributors to the performance of the laid material, Coated aggregate (nominally single size aggregate particles with a high resistance to polishing) which are lightly coated with high viscosity binder are always rolled into and form part of an HRA surface coarse. This durable material is predominantly used a surface coarse in Ireland and the UK. See Shell Bitumen Handbook 6th Edition.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The term “about” can refer to a variation of +5%, +10%, +20%, or +25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the term “about” is intended to include values, e.g., weight percentages, proximate to the recited range that are equivalent in terms of the functionality of the individual ingredient, composition, or embodiment. The term about can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

### Technical Problem

The invention addresses the problem of how to provide a transition material which prevents deterioration at the interface between flexible road surfaces and rigid structures while providing a safe and comfortable road surface for all road users.

### Solution to Problem

The inventors have surprisingly found that providing a base layer of mastic asphalt around a rigid structure embedded in the road and embedding aggregate of 2 mm to 10 mm, pre-coated with bitumen, into the surface of the mastic asphalt provides lasting skid resistance and prevents surface deformation.

### SUMMARY OF INVENTION

Provided is a transition material for the interface between a flexible surface and a rigid surface comprising
a base layer comprising mastic asphalt;
a surface layer comprising bitumen pre-coated aggregate with particle sizes in the range of 2 mm to 10 mm, as defined by sieve mesh size, embedded in the upper surface of the base layer.

The transition material provides a smooth transition from ironwork to asphaltic roads, such as HRA and SMA roads, which prevents degradation and potholing over time. It provides improved skid resistance compared to current methods for transitioning from ironworks to asphalt which involve embedding large aggregate with a particle size of approximately 30 mm into the surface of the mastic asphalt base layer. In particular, the transition material of the invention provides improved skid resistance for narrow wheels and pedestrians. It further provides improved tactile qualities such as fewer perceptible bumps compared to the current methods for providing skid resistance to transition material surrounding ironworks. Finally, it provides improved aesthetic qualities as it is visually similar to the surrounding asphalt road, which comprises aggregate of over 10 mm, typically 14 mm to 20 mm.

Optionally, the pre-coated aggregate has a particle size of 2 mm to 8 mm, as defined by sieve mesh size.

Optionally, the pre-coated aggregate has a particle size of 2 mm to 6.3 mm, as defined by sieve mesh size. Aggregate with this preferred particle size range embeds adequately into the mastic asphalt layer and provides a macrotexture which prevents skidding.

An alternative aggregate measuring system is the US Standard Mesh. Using such a system, the pre-coated aggregate has a particle size of 10 Mesh to ⅜ in, 10 Mesh to 3 Mesh, or 10 Mesh to 3.5 Mesh. Optionally the lower limit is 10, 9, 8, 7, 6 or 5 Mesh, while the upper limit is 4, 3.5, or 3 Mesh or ⅜ in. For example, the 2 mm to 6.3 mm pre-coated aggregate can be substituted by 10 Mesh to 3 Mesh pre-coated aggregate where necessary. Similarly, 2 mm to 10 mm pre-coated aggregate can be substituted by 10 Mesh to ⅜ in.

It was found that larger pre-coated aggregate, for example 6.3 mm to 8 mm, 8 mm to 10 mm, or 6.3 mm to 10 mm, while providing some effect, provided less skid resistance, less coverage and insufficient shoulder-to-shoulder coverage than the preferred size range of 2 mm to 6.3 mm. In other words, some of the mastic asphalt base layer remained exposed, particularly at the edges of the transition material, when aggregate of 6.3 mm to 10 mm was used, and particularly when aggregate of 8 mm to 10 mm was used. Aggregate larger than 10 mm resulted in an unacceptable degree of exposed mastic asphalt base layer at the edges of the transition material.

It was found that particles smaller than this preferred size range did not provide adequate macrotexture, i.e. did not provide the grip and skid resistance required for safe road surfaces. With regard in particular to pedestrians, the resulting surface has a pendulum test value (PTV) of over 36. The PTV mimics the way a heel makes contact with a floor.

The transition material of the invention provides decreased stopping distances compared to the known transition material. This effect is particularly pronounced for bicycles, rollerblades and wheelchairs.

Optionally, less than 50%, less than 40% or less than 30% of the pre-coated aggregate has a particle size of 4 mm to 6.3 mm, as defined by sieve mesh size. It has been found that a particle size of approximately 3 mm was particularly advantageous.

Optionally, 70-100% of the pre-coated aggregate has a particle size of 2 mm to 4 mm, as defined by sieve mesh size.

Optionally, less than 20%, less than 10%, less than 5% or less than 3% of the pre-coated aggregate has a particle size of less than 2 mm, as defined by sieve mesh size. Aggregate which passed through the 2 mm sieve was found not to provide the required macrotexture to prevent skidding. While it is not always possible to eliminate the presence of particles of this size, they should be limited. It has been found that when aggregate containing up to 5% particles of less than 2 mm was used, an acceptable surface resulted.

Optionally, the pre-coated aggregate gives a total coverage density of at least 50%, at least 60% or at least 70% of the total surface area of the transition material. Coverage density is measured in kg/m². Coverage density is measured by weighing the aggregate in used in a 1 m² test area (100%) and comparing the amount successfully embedded in the mastic asphalt. This is often referred to as “shoulder-to-shoulder” coverage.

The higher the coverage the better the grip and skid resistance. The required degree of skid resistance may vary depending on the location and the use of the transition material. However, for cycle paths for example, the coverage should be at least 70% to ensure safety.

Optionally, the pre-coated aggregate is pre-coated with bitumen or a 70% bitumen emulsion. This imparts skid-resistance to the surface of the aggregate and ultimately to the transition material. The pre-coating also allows the aggregate to bond with the mastic asphalt layer.

Optionally, the aggregate used for the pre-coated aggregate comprises is a high PSV aggregate (polished stone value) from quarried rock. However, any suitable aggregate may be used.

Optionally, the mastic asphalt comprises paving grade or polymer modified mastic asphalt (PMMA). This grade has been found to provide a smooth transition and prevent potholing and surface deformation.

Optionally, the mastic asphalt comprises aggregate with a maximum particle size of up to 14 mm, 12 mm, 10 mm, 8 mm, 6.3 mm or 4 mm, as defined by sieve mesh size.

Optionally, the base layer has a depth of at nominal depth 15 mm, or at least 20 mm. The effect of the traffic load on the mastic asphalt is therefore distributed throughout the depth of the base layer. Typically, approximately 20 mm is recommended for areas where vehicles are expected to cross the transition material. Layers of 15 mm to 40 mm are tolerated, depending on the grade of mastic asphalt used. Typically, layers of 15 mm to 25 mm are recommended, with 20 mm being the optimum thickness. Additional mastic asphalt bedding layers provide further efficacy against potholing.

The depth required also depends on the MA composition used. For example MA with a maximum aggregate particle size of 4 mm may be applied at a depth of 15 to 25 mm, MA with an aggregate particle size of 6 mm may be applied to a depth of 20 to 30 mm and MA with an aggregate particle size of 10 may be applied to a depth of 30 to 45 mm.

Optionally, the transition material extends at least 100 mm laterally from the rigid surface, or at least 150 mm or at least 200 mm from the rigid surface. It is recommended that the transition material extends 200 mm in each direction from the rigid surface to ensure adequate spreading of the displacement effect. However, it is acknowledged that this is not always possible, and depending on the anticipated loads, for example bicycles and pedestrians compared to lorries and buses, this may not always be essential. For roads with vehicles at least 200 mm is recommended to avoid potholing and deformation over time.

Optionally, the flexible surface is a road surface comprising hot rolled asphalt or stone mastic asphalt. These road surfaces dominate in some regions and are particularly prone to deforming and potholing around rigid components.

Optionally, the flexible surface is a footpath, wheelchair ramp or cycle path comprising hot rolled asphalt or stone mastic asphalt. Footpaths, wheelchair ramps and cycle paths in particular require the smooth surface transition afforded by the invention. Their users are particularly sensitive to changes in the texture of the road surface and bumps which do not impact vehicles can cause discomfort or even accidents to cyclists, wheelchair users and pedestrians. Furthermore, these surfaces are often confined by rigid components which may be concrete or brick walls, concrete structures and the likes and embedded with ironworks and so on.

Optionally, the rigid component is an ironwork. These often coincide with pedestrian and cycle paths.

Optionally, the transition material is coloured. Optionally the pre-coating is coloured.

Optionally, the mastic asphalt component is coloured. The colour may be red, green, blue or any other colour commonly used to designate cycle lanes. Optionally the transition material is painted after laying. Suitable paints for road surfaces are known in the art.

Also provided is a method for laying a transition material in the interface between a flexible road surface and a rigid component, comprising:
excavating the area around the rigid component,
optionally, removing the rigid component,
optionally, reinstating the rigid component,
heating mastic asphalt,
laying a base layer of mastic asphalt to the area around the rigid component, tamping pre-coated aggregate with a size of 2 mm to 10 mm as measured by sieve mesh size into the upper surface of the base layer.

A base layer may be laid before reinstating the rigid component.

The method is fast as the mastic asphalt requires no roller compaction and the tamping is straightforward. By “tamping” is meant pushing the pre-coated aggregate into the mastic asphalt layer by pressing down on it. Large equipment is not required for laying the transition material around one manhole cover for example. Typically, the process requires a two person crew. Therefore, the process is ideally suited for the reinstatement and resetting of ironworks in existing roads, as they will not need to be closed to traffic for long, and the equipment will not occupy large amounts of public space or block other lanes. The transition material is ready for traffic and footfall after approximately 45 minutes.

Optionally the method further comprises laying a bedding layer of bricks or mastic asphalt around the rigid component, under the mastic asphalt base layer.

Further bedding layers of mastic asphalt or brick are laid such that the upper surface of the top layer (the base layer) is at the same level as the surrounding road or path. The number of layers required will depend on the depth of the ironwork and other factors. All of the layers of mastic asphalt—the base layer and optionally mastic asphalt bedding layers—contribute to the effect of preventing potholing.

Preferably, the tamping is performed immediately after laying the base layer. At this stage the base layer is still at its working temperature and tamping can be done by hand. It has been found that when applied directly to the base layer immediately after laying the pre-coated aggregate embedding is not excessive—in other words, the pre-coated aggregate does not sink so far into the base layer that it does not provide the required skid-resistance or positive macrotexture. It has been found that the pre-coated aggregate embeds to a sufficient depth to resist debonding from the action of traffic.

Optionally, the pre-coated aggregate is at ambient temperature prior to tamping. Optionally, the pre-coated aggregate is not heated prior to tamping into the surface of the base layer. Typically, applying aggregate surfaces to mastic asphalt involves applying a large excess of heated aggregate to the hot mastic asphalt and allowing it to sink into the mastic asphalt layer, aided by its own weight and heat. The present method does not require the additional energy to heat the aggregate and does not require a specialised vehicles or equipment for carrying the heated aggregate or for heating it. This allows the method to be used on narrow off-road cycle lanes, wheelchair ramps and footpaths. Furthermore, only a small excess of 10-15% aggregate is applied in the present method. Excess aggregate represents a safety hazard as it can cause skidding and can be lifted off the ground by vehicles and strike road users. Large excesses also have to be removed by a further process, which results in longer road closures. By tamping ambient temperature pre-coated aggregate into the surface of the base layer, less energy is used and less aggregate can be used.

Optionally, the tamping is performed by hand. This is particularly advantageous for small areas such as the area surrounding a manhole cover or for areas which are difficult to reach with large equipment such as a wheelchair ramp or remote cycle path. However, for larger areas, a roller or similar equipment may be used. For example, if the entire length of a tramline in a city is to be resurfaced with the transition material, a roller or other mechanism may be practical. However, it is to be noted that it is possible to perform the tamping by hand and still achieve the required level of coverage since low pressures are required when pre-coated aggregate of the appropriate size is selected, even when the aggregate is kept at ambient temperature. It is also to be noted that the embedding is not excessive when the tamping is performed by hand—in other words, the pre-coated aggregate does not sink so far into the base layer that it does not provide the required skid-resistance. The pre-coated aggregate also embeds to a sufficient depth such that it resist debonding due to the action of traffic.

Optionally, the pre-coated aggregate has a particle size of 2 mm to 8 mm, or 2 mm to 6.3 mm, as defined by sieve mesh size.

Optionally, less than 50%, less than 40% or less than 30% of the pre-coated aggregate has a particle size of 4 mm to 6.3 mm, as defined by sieve mesh size.

Optionally, less than 20%, less than 10% less than 5% or less than 3% of the pre-coated aggregate has a particle size of less than 2 mm, as defined by sieve mesh size.

Optionally, the tamping is performed until the pre-coated aggregate gives a total coverage density of at least 50% of the total surface area of the transition material.

Optionally, the tamping is performed until the pre-coated aggregate gives a total coverage density of at least 60% of the total surface area of the transition material.

Optionally, the tamping is performed until the pre-coated aggregate gives a total coverage density of at least 70% of the total surface area of the transition material.

Optionally, the coverage is over 80% or over 90% of the total surface area of the transition material.

Optionally, the pre-coated aggregate is pre-coated with bitumen or a 70% bitumen emulsion. These pre-coatings allow the pre-coated aggregate to bond with the warm mastic asphalt base layer under a small amount of pressure, even when the aggregate is at ambient temperature.

Optionally, the mastic asphalt comprises paving grade or polymer modified mastic asphalt (PMMA). These provide the appropriate smooth transition to prevent potholing and deformation. Such mastic asphalt can be brought to the site as a solid and heated to the working temperature in small batches, as required, meaning energy is not wasted heating more than necessary and specialised vehicles for transporting hot asphalt are not required. Furthermore, it is long lasting.

Optionally, the mastic asphalt comprises aggregate with a maximum particle size of up to 14 mm, 12 mm, 10 mm, 8 mm, 6.3 mm or 4 mm, as defined by sieve mesh size.

Optionally, the base layer of mastic asphalt to the area around the rigid component comprises laying a base layer of a depth of at least 15 mm, or at least 20 mm.

Optionally, laying the base layer of mastic asphalt to the area around the rigid component comprises laying a base layer which extends laterally at least 100 mm from the rigid surface, or at least 150 mm or at least 200 mm from the rigid surface.

Optionally, the flexible road surface is hot rolled asphalt or stone mastic asphalt.

Optionally, the flexible road surface is a footpath, wheelchair ramp or cycle path comprising hot rolled asphalt or stone mastic asphalt.

Optionally, the rigid component is an ironwork.

The transition material optionally further comprises at least one bedding layer of brick or mastic asphalt, optionally PMMA, depending on the depth of the ironwork, to bring the top surface of the base layer up to the level of the surrounding asphalt road.

Optionally a bond coat is applied to the bottom of the excavated area around the rigid component.

Optionally, the mastic asphalt is heated to a temperature of 100° C. to 170° C., more preferably 120° C. to 150° C., and typically about 120° C. for application.

Where multiple mastic asphalt layers, including the base layer and mastic asphalt bedding layers, are added, the receiving layer's temperature should not exceed 75° C. prior to laying of a subsequent layer.

### BRIEF DESCRIPTION OF DRAWINGS

FIG. 1 is a top view the transition material currently in use;

FIG. 2 is a top view of the transition material of the present invention;

FIG. 3 is a cross section view of the transition material of the present invention;

FIG. 4 is a flow chart of the method of applying the transition material of the present invention.

### DESCRIPTION OF EMBODIMENTS

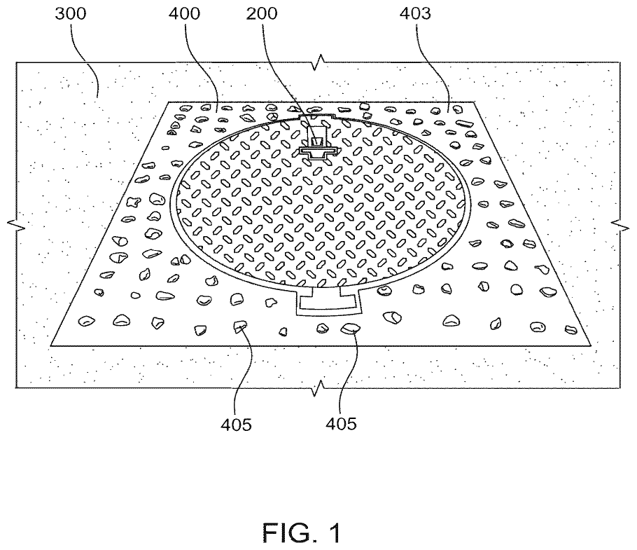

FIG. 1 shows the current state of the art. A standard manhole cover 200 (which is a type of ironwork) is embedded in an asphalt road 300 comprising aggregate of 10-14 mm. The transition material 400 between the asphalt and the ironworks comprises a mastic asphalt base layer 403. The base layer 403 is embedded with large pre-coated aggregate 405 of approximately 30 mm in size, spaced approximately 100 mm apart. As can be seen, large areas of the surface of the base layer 403 are exposed.

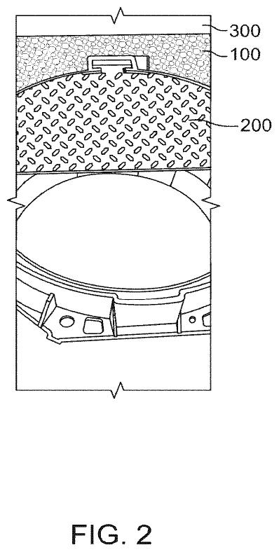

FIG. 2 shows the transition material of the present invention. A standard manhole cover (which is a type of ironwork) is installed in an asphalt road, wherein the asphalt road comprises aggregate of 10 mm to 14 mm. The transition material between the asphalt and the ironworks comprises mastic asphalt and is surfaced with pre-coated aggregate which predominantly falls in the size range 2 mm to 4 mm. The pre-coated aggregate used in the example has a range from 2 mm to 6.3 mm. The pre-coated aggregate was pre-coated with bitumen prior to tamping into the mastic asphalt.

The mastic asphalt is polymer modified mastic asphalt which has additives to give it a lower working temperature than non-polymer modified mastic asphalt.

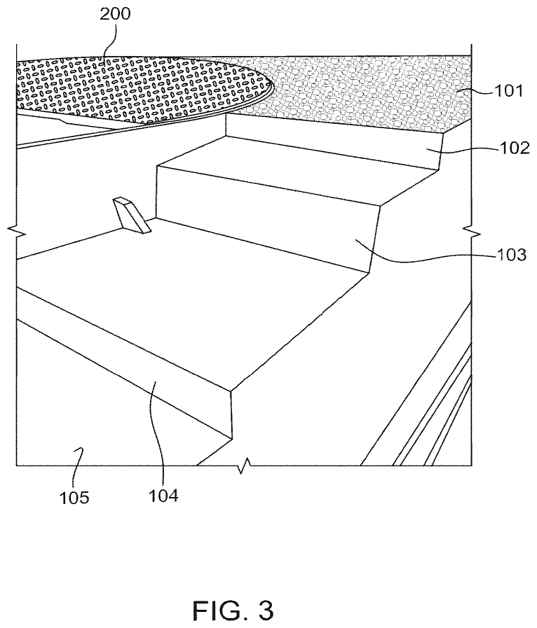

FIG. 3 shows a cross section of the transition material of the present invention. There can be seen the layers of the transition material from top to bottom.

The surface layer 101 of pre-coated aggregate of 2 mm to 6.3 mm comprises one layer of pre-coated aggregate tamped into the base layer 102 of mastic asphalt. The base layer 102 has a depth of 20 mm.

This arrangement also comprises further bedding layers of mastic asphalt 103, 104, 105 which were laid to bring the top of the base layer 102 to the same level as the surrounding road. Each layer of mastic asphalt (102, 103, 104, 105) has a depth or thickness of approximately 20 mm.

In FIG. 3, the transition material extends laterally for at least 20 cm in each direction from the ironwork.

The surface of the transition material comprises aggregate of 2 mm to 6.3 mm pre-coated with bitumen. In other words, the aggregate passes through the 6.3 mm mesh but not through the 2 mm mesh.

In the following examples, more than half of the aggregate has a size over 3 mm, which is the preferred lower limit. More than half of the aggregate used in the examples passes through the 4 mm mesh. In examples 1-3, aggregate having the compositions of Table 1 was used for the surface of the transition material.

TABLE 1
Pre-coated aggregate size

| | | Example 1: | Example 2: | Example 3: | |
|---|---|---|---|---|---|
| Sieve | | Percent | Percent | Percent | Preferred |
| size | | passing | passing | passing | limits |
| 8 | mm | 100 | 100 | 100 | 100-100 |
| 6.3 | mm | 100 | 100 | 100 | 98-100 |
| 4 | mm | 68 | 77 | 83 | 70-100 |
| 2 | mm | 3 | 3 | 5 | 0-20 |
| 1 | mm | 0 | 0 | 0 | 0-10 |
| 0.5 | mm | 0 | 0 | 0 | 0-5 |

The aggregate preferably has a flakiness index of less than or equal to 35. The above preferred limits show the preferable range of size for the surface aggregate for the transition material of the invention. However, aggregate up to 10 mm may also be used.

The mastic asphalt component of the transition material comprises bitumen and aggregate. The bitumen can be paving grade or polymer modified bitumen. The preferred bitumen is a polymer modified paving grade bitumen. This mastic asphalt mixture has the advantages of being able to be heated on site, leftover mixture may be reheated and there is no need for roller compaction. The material may be delivered to the site in solid form. It furthermore has the required strain absorbing properties. Harmonised European Standards (hENs) provide assessment methods and performance requirements for construction products, including mastic asphalt. Preferably, the mastic asphalt used complies with some of the following Harmonised European Standards:
i. IS EN 13108-6 Bituminous Mixtures-Material Specifications-Mastic Asphalt
ii. IS EN 13108-20 Bituminous Mixtures-Material Specifications-Type Testing
iii. IS EN 13108-21 Bituminous Mixtures-Material Specifications-Factory Production Control
iv. IS EN 12591 Bitumen and bituminous binders-Specifications for paving grade bitumens
v. IS EN 14023 Bitumen and bituminous binders-Specification framework for polymer modified bitumens
vi. IS EN 13043 Aggregates for bituminous mixtures and surface treatments for roads, airfields and other trafficked areas

Where hENs refer to Construction Product Directive 8106/EEC the provisions of Construction Product Regulation (EU) No. 305/2011 prevail over any conflicting provisions of the hENs. To assist in understanding the different terminology that exists between the Directive and the Regulation, CCSPW-00010 contains the equivalent terms.

The designation of mastic asphalt (MA) is followed by an indication of the particle size of the aggregate in the mixture in millimetres (mm) as measured by sieve mesh size and the binder designation.

For example, MA with a maximum aggregate size of 6 mm and a 40/60 paving grade binder is designated MA 6 40/60. Polymer modified bitumen is denoted PBM.

The following designations may be used in accordance with the invention: MA 4 40/60, MA 4 PMB 25/55-60, MA 4 PMB 65/105-70, MA 6 40/60 MA 6 PMB 25/55-60, MA 6 PMB 65/105-70, MA 10 40/60, MA 10 PMB 25/55-60, MA 10 PMB 65/105-70. However, any suitable composition may be used.

MA suitable for the invention contains aggregates which may have a maximum sieve size of up to 14 mm, 12 mm, 10 mm, 8 mm, 6.3 mm or 4 mm. These are not to be confused with the pre-coated aggregate used for the surface layer of the invention. Examples of some preferred possible aggregate particle size ranges for the mastic asphalt component of the transition material are given in Table 2.

TABLE 2
Aggregate in mastic asphalt size:

| | | | |
|---|---|---|---|
| Sieve size | Example A | Example B | Example C |

| | | | | |
|---|---|---|---|---|
| 16 | mm | | | |
| 14 | mm | | | 100 |
| 10 | mm | | | 90-100 |
| 8 | mm | | 100 | |
| 6.3 | mm | 100 | 90-100 | |
| 4 | mm | 90-100 | | |
| 2 | mm | 65-80 | 55-70 | 49-64 |
| 0.063 | mm | 37-45 | 28-36 | 26-34 |

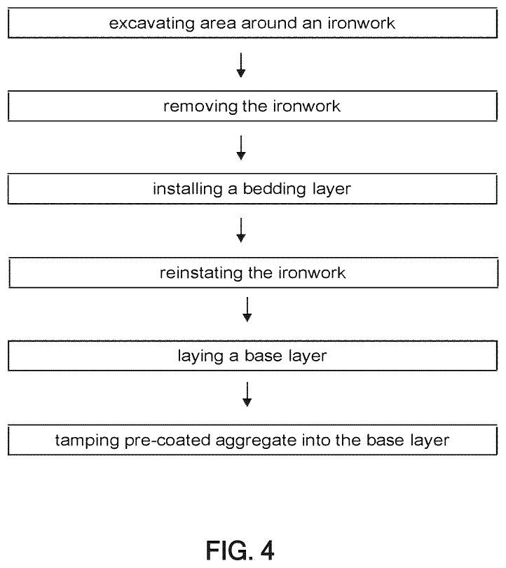

FIG. 4 is a flow chart describing the steps for the method of installing the transition material of the invention. Briefly the method consists of:
excavating the area around the ironwork,
optionally, removing the ironwork,
optionally, installing a bedding layer,
optionally, reinstating the ironwork,
laying a base layer of mastic asphalt to the area around the ironwork,
tamping pre-coated aggregate of 2 mm 10 mm into the mastic asphalt.

In one example application, mastic asphalt was delivered to the works site in a purpose-built unit with an agitator capable of heating the mastic asphalt to the application temperature of 150° C. and maintaining it at that temperature.

A square perimeter at a minimum of 200 mm from the edge of a manhole cover around the manhole cover was marked out. The marked perimeter was cut with a saw to a depth of 50 mm to uncover the edged of the manhole cover, and the manhole cover was removed along with all old bedding material. The faces of all upstanding edges were smoothed. Bond coat was applied to the bottom of the excavated area.

Multiple bedding layers of mastic asphalt were laid. The manhole cover was lowered into position on top of a bedding layer. Further bedding layers of mastic asphalt were applied so that the top layer of mastic asphalt, the base layer, had an upper surface at the same level as the surrounding road surface.

Pre-coated aggregate with a size of 2 mm to 6.3 mm was immediately applied to the surface and rolled into the surface to give a coverage of over 70%.

The area was re-opened to traffic when the mastic asphalt returned to ambient temperature.

In another example application, the method differed only in that the mastic asphalt was delivered to the site in block form and melted in a mechanically agitated cauldron and maintained at the application temperature.

In another example, the method differed only in that the pre-coated aggregate was tamped into the surface of the base layer by hand.

### Example 4: Skid Testing

Portable skid resistance value testing was conducted on the surface of the transition material in accordance with EN13036-4:2011 with the following parameters:
Specimen type: flat
Test type: wet
Slider width: wide
Slider number: 881032/3
Slider type: CEN 57

TABLE 3
Test Results

| Test | | Distance to | | Mean | Mean |
|---|---|---|---|---|---|
| No. | Location | Kerb (m) | Direction | PTV | PTV_{corr} |
| 1 | 3-6 mm Precoated | 2.4 | Outbound | 84 | 81 |
| | Section | 2.4 | Perpendicular | 83 | 80 |
| 2 | Composite Cover | 2.6 | Outbound | 71 | 68 |
| | | 2.6 | Perpendicular | 54 | 51 |
| 3 | 14 mm Precoated | 2.1 | Outbound | 49 | 46 |
| | Area | 2.1 | Perpendicular | 57 | 54 |
| 4 | 3-6 mm Precoated | 1.9 | Outbound | 86 | 82 |
| | Section | 1.9 | Perpendicular | 77 | 73 |
| 5 | Metal Cover | 2.5 | Outbound | 62 | 59 |
| | | 2.5 | Perpendicular | 53 | 50 |

Perpendicular = perpendicular to traffic

A high pendulum test value (PTV) indicates good skid resistance. Low values indicate a higher probability of a slip.

The above table demonstrates the effect of the particle size of the surface aggregate of the transition material on the PTV. Transition material with pre-coated 3-6 mm aggregate embedded in the surface has a higher PTV value than the 14 mm comparative example.

### REFERENCE SIGNS LIST

100 transition material
101 surface layer
102 mastic asphalt base layer
103, 104, 105 bedding layers of mastic asphalt
200 manhole cover
300 surrounding road
400 prior art transition material
403 prior art mastic asphalt base layer
405 large pre-coated aggregate

1. A transition material for the interface between a flexible surface and a rigid surface comprising
a base layer comprising mastic asphalt;
a surface layer comprising bitumen pre-coated aggregate with particle sizes in the range of about 2 mm to about 10 mm, as defined by sieve mesh size, embedded in the upper surface of the base layer.

2. The transition material of claim 1 wherein the pre-coated aggregate has a particle size of about 2 mm to about 8 mm, as defined by sieve mesh size.

3. The transition material of claim 2 wherein the pre-coated aggregate has a particle size of about 2 mm to about 6.3 mm, as defined by sieve mesh size.

4. The transition material of claim 1 wherein less than about 50%, less than about 40% or less than about 30% of the pre-coated aggregate has a particle size of about 4 mm to about 6.3 mm, as defined by sieve mesh size; and/or wherein less than about 20%, less than about 10% less than about 5% or less than about 3% of the pre-coated aggregate has a particle size of less than about 2 mm, as defined by sieve mesh size; and/or wherein about 70-100% of the pre-coated aggregate has a particle size of about 2 mm to about 4 mm, as defined by sieve mesh size.

5. The transition material of claim 1 wherein the pre-coated aggregate gives a total coverage density of at least about 50% of the total surface area of the transition material; or a total coverage density of at least about 60% of the total surface area of the transition material; or a total coverage density of at least about 70% of the total surface area of the transition material.

6. The transition material of claim 1 wherein the transition material extends laterally at least about 100 mm from the rigid surface, or at least about 150 mm or at least about 200 mm from the rigid surface.

7. The transition material of claim 1 wherein the flexible surface is a road surface comprising hot rolled asphalt or stone mastic asphalt; optionally wherein the flexible surface is a footpath, wheelchair ramp or cycle path comprising hot rolled asphalt or stone mastic asphalt.

8. The transition material of claim 1 wherein the rigid component is an ironwork.

9. A method for laying a transition material at the interface between a flexible road surface and a rigid component, the method comprising
excavating the area around the rigid component,
optionally, removing the rigid component,
optionally, reinstating the rigid component,
heating mastic asphalt,
laying a base layer of mastic asphalt to the area around the rigid component, tamping pre-coated aggregate with a size of about 2 mm to about 10 mm, as measured by sieve mesh size, into the upper surface of the base layer.

10. The method of claim 9, further comprising laying a bedding layer of bricks or mastic asphalt around the rigid component, under the mastic asphalt base layer.

11. The method of claim 9, wherein the pre-coated aggregate is at ambient temperature prior to tamping.

12. The method of claim 9, wherein the pre-coated aggregate has a particle size of about 2 mm to about 8 mm, as defined by sieve mesh size.

13. The method of claim 12, wherein the pre-coated aggregate has a particle size of about 2 mm to about 6.3 mm, as defined by sieve mesh size.

14. The method of claim 9, wherein less than about 50%, less than about 40% or less than about 30% of the pre-coated aggregate has a particle size of about 4 mm to about 6.3 mm, as defined by sieve mesh size; and/or wherein less than about 20%, less than about 10% less than about 5% or less than about 3% of the pre-coated aggregate has a particle size of less than about 2 mm, as defined by sieve mesh size.

15. The method of claim 9, wherein the tamping is performed until the pre-coated aggregate gives a total coverage density of at least about 50% of the total surface area of the transition material; or at least about 60% of the total surface area of the transition material; or at least about 70% of the total surface area of the transition material.

16. The method of claim 9, wherein the mastic asphalt comprises aggregate with a maximum particle size of up to about 14 mm, about 12 mm, about 10 mm, about 8 mm, about 6.3 mm or about 4 mm, as defined by sieve mesh size.

17. The method of claim 9, wherein laying the base layer of mastic asphalt to the area around the rigid component comprises laying a base layer of a depth of at least about 15 mm, or at least about 20 mm.

18. The method of claim 9, wherein laying the base layer of mastic asphalt to the area around the rigid component comprises laying a base layer which extends laterally at least about 100 mm from the rigid surface, or at least about 150 mm or at least about 200 mm from the rigid surface.

19. The method of claim 9, wherein the rigid component is an ironwork.

20. The method of claim 9, wherein the pre-coated aggregate is applied with an excess of less than about 15%.
